(19) United States
(12) Patent Application Publication
(10) Pub. No.: US 2009/0266000 A1
(43) Pub. Date: Oct. 29, 2009

(54) Weather strip for motor vehicle

(75) Inventors: Hideaki Minoura, Aichi-ken (JP); Masatoshi Hotta, Aichi-ken (JP); Hirofumi Otsuka, Aichi-ken (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: TOYODA GOSEI CO., LTD., Aichi-ken (JP)

(21) Appl. No.: 12/385,874

(22) Filed: Apr. 22, 2009

(30) Foreign Application Priority Data
Apr. 24, 2008 (JP) 2008-113998
Dec. 3, 2008 (JP) 2008-308456

(51) Int. Cl. E06B 7/16

(52) U.S. Cl. 49/490.1

(57) ABSTRACT

A weather strip for a motor vehicle, which is capable of meeting the need for the provision of a lightweight motor vehicle, and exhibiting a great holding force against a flange of a vehicle body. The weather strip includes a trim portion having a generally U-shaped cross-section and a tubular seal portion. The trim portion includes an outer side wall, a bottom wall and an inner side wall, flange holding lips extend in an interior of the trim portion, and the tubular seal portion is formed near a center of an exterior surface of the bottom wall via a neck portion. An exterior surface of a corner portion between the bottom wall and the outer side wall, and an exterior surface of a corner portion between the bottom wall and the inner side wall are respectively formed to have an angle of 90° through 100°, angular parts of both the corner portions are formed with a radius of curvature of 0.2 mm through 2.0 mm, and the outer side wall, the bottom wall and the inner side wall respectively exhibit a JIS hardness of 75 through 100, and are respectively formed of a hard material of rubber or a thermoplastic elastomer with an apparent specific gravity of not less than 0.8.

### CROSS-REFERENCE TO RELATED APPLICATION

This application is related to and claims priority from Japanese patent applications No. 2008-113998 and 2008-308456, incorporated herein by reference.

### BACKGROUND OF THE INVENTION

1. Field of the Invention

The present invention relates to a weather strip for attachment to a flange provided in an opening surface around an opening in a body of a motor vehicle.

2. Description of Related Art

A motor vehicle has openings such as door openings, a trunk room openings, etc., and weather strips are attached to opening surfaces around these openings to effect seals between the opening surfaces and closing members for closing the openings, such as doors, trunk lids, etc.

Upon attaching these weather strips to the opening surfaces, normally, flanges provided in the opening surfaces are inserted in interior spaces of trim portions of the weather strips.

For example, in order to seal around an opening of a rear trunk of a motor vehicle, as shown in FIG. 1, a weather strip 10 is attached to a flange 12 provided in an opening surface 14 of a vehicle body so as to face a periphery of a trunk lid 16 of the rear trunk.

The weather strip 10 has a trim portion 18 for attachment to the flange 12, and a tubular seal portion 20 for contacting and sealing a rear face of the trunk lid 16.

The trim portion 18 includes an outer side wall 22, an inner side wall 24 and a bottom wall 26, and has a generally U-shaped cross-section, and in order to strengthen the holding of the flange 12, an insert 28 of a metal plate is embedded in the trim portion 18.

Outer flange holding lips 30 and 32 and inner flange holding lips 34 and 36 respectively extend obliquely from interior faces of the outer side wall 22 and the inner side wall 24 in an interior space of the trim portion 18 towards the bottom wall 26. These flange holding lips 30, 32, 34 and 36 hold the flange 12.

Upon attaching the weather strip 10 to the flange 12, the flange 12 provided around the opening of the rear trunk is inserted in the interior space of the trim portion 18. The trim portion 18 has the outer flange holding lips 30 and 32 and the inner flange holding lips 34 and 36, and these flange holding lips 30, 32, 34 and 36 of which the holding force is strengthened with the insert 28, hold and seal the flange 12 along with a sponge sealer 38, thereby retaining the posture of the trim portion 18 and preventing the trim portion 18 from coming off the flange 12. And the tubular seal portion 20 contacts and seals the rear face of the trunk lid 16.

In many cases, the insert 28 is made of metal for strengthening the holding force of the trim portion 18, and consequently, the entire weight of the weather strip 10 increases so as not to be less preferable, considering the need for lightweight motor vehicles.

Under the above-described circumstances, as shown in FIG. 2, there has been proposed to form an outer side wall 40, an inner side wall 42 and a bottom wall 44 of a trim portion 46 of a weather strip 48 having a tubular seal portion 50 of a hard rubber or a hard resin without embedding a metallic insert in the trim portion 46 (see Japanese Patent No. 3752627, for example.).

And, as shown in FIG. 3, there has been also proposed to form an outer side wall 52, an inner side wall 54 and a bottom wall 56 of a trim portion 58 of a weather strip 60 having a tubular seal portion 62 of a hard rubber, a hard thermoplastic resin, a hard thermosetting resin, etc. without embedding any metallic insert in the trim portion 58 (see U.S. Pat. No. 5,626,383, for example.).

In addition, there has been also proposed to form an outer side wall, an inner side wall and a bottom wall of a trim portion of a shape memory rubber body without embedding any metallic insert in the trim portion (see Japanese Patent application laid-open No. 2001-130344, for example.).

In these cases, no metallic insert is embedded so that the weather strip can be made lightweight, but the flange holding force of the trim portion decreases, whereby the trim portion may come off the flange. In order to increase the flange holding force, there has been proposed to increase the wall thickness of the trim portion or the flange holding lips, but the weight of the trim portion increases so as not to meet the need for lightweight motor vehicles.

### SUMMARY OF THE INVENTION

Accordingly, it is an object of the present invention to provide a weather strip for a motor vehicle, in which no insert is used to meet the need for providing lightweight motor vehicles, and which exhibits a great holding force against a flange of a vehicle body.

In accordance with a first aspect of the present invention, a weather strip for a motor vehicle, which is to be attached to a flange around an opening in a vehicle body for sealing an opening surface of the vehicle body against a facing member, includes a trim portion with a generally U-shaped cross-section, adapted to be attached to the flange and holding the weather strip, and a tubular seal portion integrally formed with the trim portion for contacting the facing member and effecting a seal between the opening surface and the facing member. The trim portion has an outer side wall, a bottom wall and an inner, side wall. Flange holding lips respectively extend from interior surfaces of the outer side wall and the inner side wall. An exterior surface of a corner between the bottom wall and the outer side wall, and an exterior surface of a corner between the bottom wall and the inner side wall are formed to have an angle of 90° through 100°, and angular parts in both corners are formed with a radius of curvature of 0.2 mm through 2.0 mm. And the outer side wall, the bottom wall and the inner side wall respectively exhibit a JIS hardness of 75 through 100, and are formed of a hard material of rubber or a thermoplastic elastomer with an apparent specific gravity of not less than 0.8.

With this arrangement, the weather strip includes a trim portion with a U-shaped cross-section, which is to be attached to the flange for holding the weather strip, and a tubular seal portion integrally formed with the trim portion for contacting the facing member and effecting a seal between the opening surface and the facing member. By attaching the trim portion to the flange, the weather strip can be held. And the trim portion attached to the flange retains the posture of the weather strip without tilting downwardly, and consequently, the tubular seal portion securely contacts the facing member to provide a seal between the opening surface and the facing member.

The trim portion has a generally U-shaped cross-section composed of an outer side wall, a bottom wall and an inner side wall, flange holding lips respectively extend from interior surfaces of the outer side wall and the inner side wall. Consequently, the flange can be held stably with the outer flange holding lips and inner flange holding lips so that the weather strip can be attached with the trim portion with a generally U-shaped cross-section, which exhibits rigidity.

The exterior surface of a corner between the bottom wall and the outer side wall, and the exterior surface of a corner between the bottom wall and the inner side wall are formed to have an angle of 90° through 100° so that the angle between the outer side wall and the bottom wall, and the angle between the bottom wall and the inner side wall are determined to a right angle or an obtuse angle close to a right angle, and upon attached to the flange, the outer side wall and the inner side wall are difficult to spread outwardly. In addition, the opening of the trim portion is prevented from becoming narrow, thereby facilitating the insertion of the flange in the trim portion.

Angular parts in the exterior surface of the corner between the bottom wall and the outer side wall, and the exterior surface of the corner between the bottom wall and the inner side wall are formed to have a radius of curvature of 0.2 mm through 2.0 mm so that in the angular parts in both corners, no space is formed, whereby the rigidity thereof is improved, and the flange holding forces with the outer side wall and the inner side wall increase, and consequently, the trim portion is prevented from coming off the flange in spite of no insert being embedded. In addition, by forming the angular parts with a radius of curvature of 0.2 mm through 2.0 m, the angular parts exhibit their operational effects, thereby obtaining higher rigidity. When the radius of curvature is less than 0.2 mm, the production of the weather strip may scatter to make the stable production difficult, and when the radius of curvature exceeds 2.0 mm, the operational effects of the angular parts decrease to lower the rigidity thereof.

The outer side wall, the bottom wall and the inner side wall respectively exhibit a JIS hardness of 75 through 100, and are formed of a hard material of rubber or a thermoplastic elastomer with an apparent specific gravity of not less than 0.8 so that the rigidity of the entire part of the trim portion increases and the flange holding force becomes great in spite of no insert being embedded. Since the rubber or thermoplastic elastomer is extruded without using any insert, the extrusion is facilitated, and the productivity is high. Since no insert is used, the weight of the weather strip can be reduced. When the JIS hardness becomes less than 75°, the rigidity of the entire part of the trim portion decreases to reduce the flange holding force, whereas when the JIS hardness becomes greater than 100, the bending force for corners increases upon attaching the weather strip to the flange. When the specific gravity is less than 0.8, the rigidity of the entire part of the trim portion decreases to reduce the flange holding force thereof.

In accordance with a second aspect of the present invention, the flange holding lips respectively exhibit a JIS hardness of 65 through 75, and are respectively formed of rubber or a thermoplastic elastomer with an apparent specific gravity of not less than 0.8.

With this arrangement, since the flange holding lips respectively exhibit a JIS hardness of 65 through 75, and are respectively formed of rubber or a thermoplastic elastomer with an apparent specific gravity of not less than 0.8, the flange holding lips exhibit such sufficient flexibility as to flexibly contact the flange where there are irregularities on surfaces of the flange, thereby exhibiting such a sufficient rigidity as to hold the flange. Where the JIS hardness is lower than 65, the flange holding force decreases, and where the hardness becomes higher than 75°, the flexibility of the holding lip decreases.

In accordance with a third aspect of the present invention, the tubular seal portion is composed of a sponge material.

With this arrangement, since the tubular seal portion is composed of a sponge material, the tubular seal portion can flexibly contact an opening surface of the vehicle body, or a facing member to seal the same securely if the configuration thereof has irregularities and curves.

In accordance with a fourth aspect of the present invention, the tubular seal portion is formed near a center of an exterior surface of the bottom wall via a neck portion.

With this arrangement, since the tubular seal portion is formed near a center of an exterior surface of the bottom wall via a neck portion, upon attaching the weather strip to the flange, the tubular seal portion securely contacts a facing member facing the flange, thereby sealing the same. In addition, the tubular seal portion is formed via the neck portion so that the tubular seal portion freely flexes, thereby providing seal in conformity with the configuration of the facing member.

In accordance with a fifth aspect of the present invention, the neck portion is composed of a solid material.

With this arrangement, the neck portion is composed of a solid material so that the neck portion exhibits high rigidity to hold the tubular seal portion in a stable position, whereby when the tubular seal portion contacts the opening surface of the vehicle body, or the facing member, the contacting position becomes stable to ensure good sealing properties.

In accordance with a sixth aspect of the present invention, a body seal lip extends from an opening end of the outer side wall outwardly and obliquely downward to contact the opening surface of the vehicle body.

With this arrangement, a body seal lip extends from an opening end of the outer side wall outwardly and obliquely downward to contact the opening surface of the vehicle body so that rainwater, dust, noise, etc. are prevented from intruding into the trim portion from the opening surface of the vehicle body via the flange, thereby providing a seal between the opening surface of the vehicle body and the weather strip.

In accordance with a seventh aspect of the present invention, a sub-body seal lip extends from an opening end of the outer side wall inwardly and obliquely downward to contact a position near a root of the flange, and a cover lip projects from an opening end of the inner side wall inwardly to contact an inner body panel.

With this arrangement, since the sub-body seal lip extends from an opening end of the outer side wall inwardly and obliquely downward to contact the position near a root of the flange, the sub-body seal lip can contact the position between the opening surface of the vehicle body and the root of the flange upon attaching the weather strip to the flange, whereby a double seal can be effected with the body seal lip and the sub-body seal lip, and consequently, the sealing properties can be further improved.

Since the cover lip projects from an opening end of the inner side wall inwardly to contact an inner body panel, after attaching the weather strip to the flange, the cover lip covers ends of a garnish, panel, etc. provided in a vehicle compartment, to provide seals between the weather strip, the garnish and the panel, and cover gaps therebetween, thereby improving appearance therearound.

In accordance with an eighth aspect of the present invention, the flange holding lips include two flange holding lips formed in an interior surface of the outer side wall and two flange holding lips formed in an interior surface of the inner side wall in deviated positions from each other

With this arrangement, since the flange holding lips include two flange holding lips formed in an interior surface of the outer side wall and two flange holding lips formed in an interior surface of the inner side wall in deviated positions from each other, the flange can be stably held with flange holding lips composed of two flange holding lips projecting from the outer side wall and two flange holding lips projecting from the inner side wall.

In accordance with a ninth aspect of the present invention, the weather strip is composed of an EPDM rubber or a thermoplastic olefin elastomer.

With this arrangement, the weather strip is composed of an EPDM rubber or a thermoplastic olefin elastomer so that the co-extrusion can be performed using the same kind of material and consequently, the weather strip exhibiting a good weather resistance can be obtained where both the sponge material and the solid material are composed of the EPDM rubber or the thermoplastic olefin elastomer. In addition, since these materials are an olefin resin and an olefin rubber, they are not separated from each other so as to be recycled, whereby readily recyclable weather strips can be obtained.

In accordance with a tenth aspect of the present invention, the weather strip is a trunk weather strip or a back door weather strip.

With this arrangement, a closing member for an opening provided in the vehicle body is a door, the weather strip is a trunk weather strip or a back door weather strip so that rainwater, dust, etc. intruding between a trunk and a trunk lid, or between the opening surface and a back door can be securely sealed, and noise intruding into a vehicle compartment can be securely prevented.

In accordance with an eleventh aspect of the present invention, a thick wall part is provided inside a corner between the bottom wall and the outer side wall, or a corner between the bottom wall and the inner side wall.

With this arrangement, since the thick wall part is provided inside the corner between the bottom wall and the outer side wall, or the corner between the bottom wall and the inner side wall, the rigidity of the corner between the bottom wall and the outer side wall, or the corner between the bottom wall and the inner side wall is enhanced, and consequently, the flange holding force with the trim portion becomes great, thereby holding the flange securely.

In accordance with the present invention, the exterior surface of the corner between the bottom wall and the outer side wall, and the exterior surface of the corner between the bottom wall and the inner side wall are formed to have an angle of 90° through 100° so that the angle between the outer side wall and the bottom wall, and the angle between the bottom wall and the inner side wall are determined to a right angle or an obtuse angle close to a right angle to prevent an opening of the trim portion from becoming narrow, thereby facilitating the insertion of the flange in the trim portion.

Angular parts in the exterior surface of the corner between the bottom wall and the outer side wall, and the exterior surface of the corner between the bottom wall and the inner side wall are respectively formed to have a radius of curvature of 0.2 mm through 2.0 mm so that the rigidity of both corners is improved, and the flange holding forces with the outer side wall and the inner side wall increase, and consequently, the trim portion is prevented from coming off the flange in spite of no insert being embedded.

Other objects, features, and characteristics of the present invention will become apparent upon consideration of the following description and the appended claims with reference to the accompanying drawings, all of which form a part of this specification.

### BRIEF DESCRIPTION OF THE DRAWINGS

FIG. 1 is a cross-sectional view of one example of a conventional weather strip;

FIG. 2 is a cross-sectional view of another example of a conventional weather strip;

FIG. 3 is a cross-sectional view of still another example of a conventional weather strip;

FIG. 4 shows a first embodiment of a weather strip in accordance with the present invention, which is attached to a vehicle body, taken along line A-A of FIG. 6;

FIG. 5 shows a second embodiment of a weather strip in accordance with the present invention, which is attached to a vehicle body, taken along line A-A of FIG. 6; and

FIG. 6 is a schematic perspective view of a motor vehicle, seen from an obliquely upward position thereof.

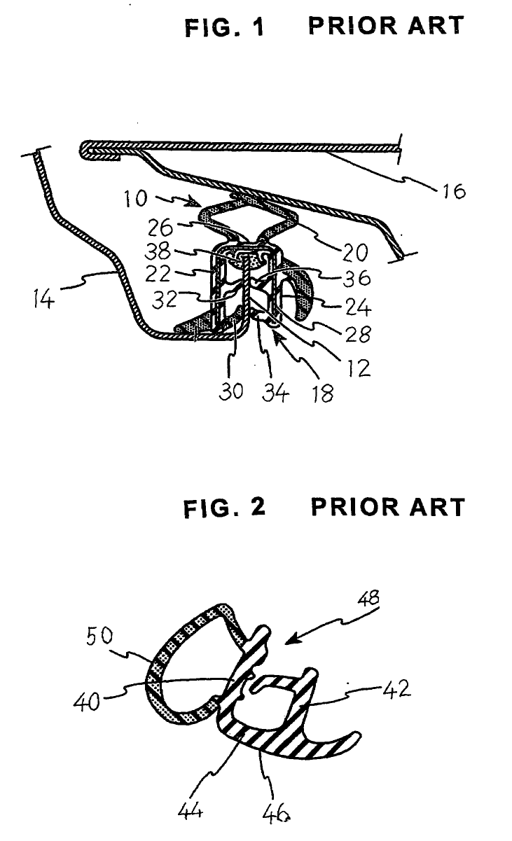

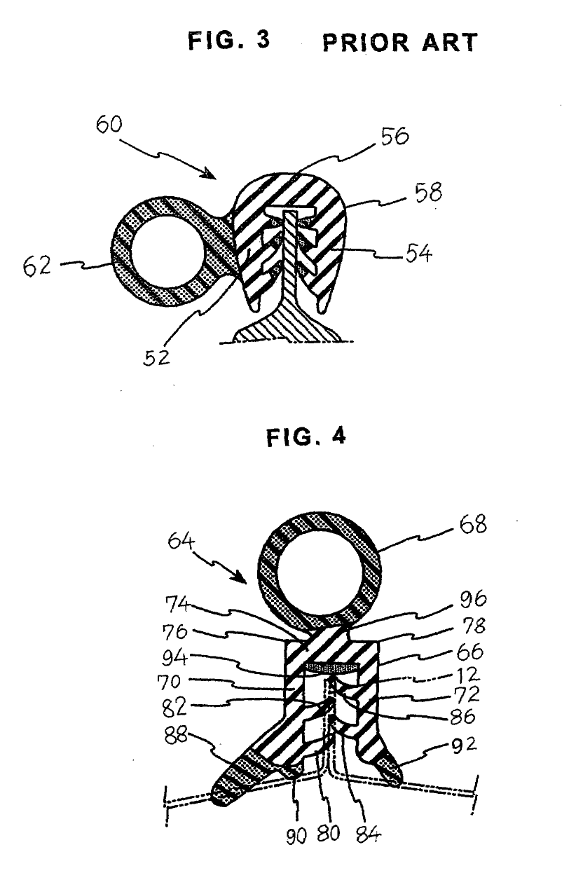

### DETAILED DESCRIPTION OF THE PREFERRED EMBODIMENTS

Hereinafter, embodiments of the present invention will be explained with reference to FIG. 4 through FIG. 6.

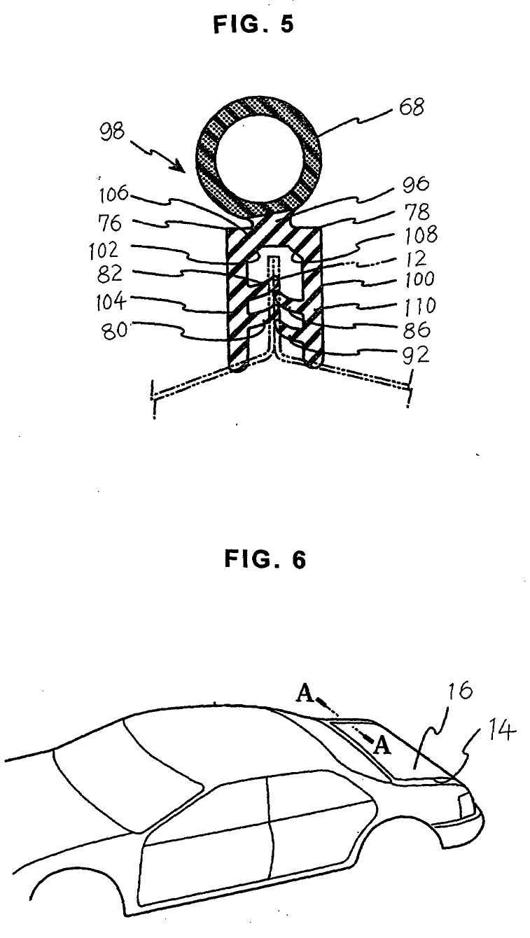

FIG. 4 shows a first embodiment of the present invention, and is a cross-sectional view of a weather strip 64 prior to attachment to a vehicle body, taken along line A-A of FIG. 6. FIG. 5 shows a second embodiment of the present invention, and is a cross-sectional view of a weather strip 98 prior to attachment to a vehicle body, taken along line A-A of FIG. 6. FIG. 6 is a schematic perspective view of a motor vehicle, seen from an obliquely left and upper side thereof, and shows the relation between an opening surface 14 and a trunk lid 16 in a rear trunk.

Embodiments of the present invention will be explained with reference to weather strips to be attached to the rear trunk. The present invention can be also applied to a back door weather strip and other weather strips adapted to seal openings formed in motor vehicles, such as door openings, roof openings, etc.

In the first embodiment, as shown in FIG. 4, the weather strip 64 has a trim portion 66 for attachment to a flange 12 and a tubular seal portion 68 for contacting a reverse surface of the trunk lid 16 and sealing the same.

The trim portion 66 includes an outer side wall 70, an inner side wall 72 and a bottom wall 74 with a generally U-shaped cross-section. Such inserts of fish-bone shaped metal elements are not embedded therein. The outer side wall 70, the inner side wall 72 and the bottom wall 74 are composed of a hard material of rubber or a thermoplastic elastomer.

The outer side wall 70 and the bottom wall 74 are jointed to each other via a corner portion such that an exterior surface thereof is formed to make an angle of 95° between the outer side wall 70 and the bottom wall 74. Similarly, the inner side wall 72 and the bottom wall 74 are jointed to each other via another corner portion such that an exterior surface thereof is formed to make an angle of 95° between the inner side wall 72 and the bottom wall 74.

Consequently, each corner portion is formed to have an obtuse angle so as to prevent an opening area of the trim portion 66 from decreasing, whereby the outer side wall 70 and the inner side wall 72 extend in parallel, or are slightly splayed toward opening ends thereof so that the flange 12 can be readily inserted in the trim portion 66.

An angular part 76 in the exterior surface of the corner portion between the outer side wall 70 and the bottom wall 74 and an angular part 78 in the exterior surface of the corner portion between the bottom wall 74 and the inner side wall 72 are respectively formed with a radius of curvature of 0.5 mm. Therefore, the rigidity of the corner portions is improved to prevent the outer side wall 70 and the inner side wall 72 from opening about corner portions thereof, thereby increasing the flange holding force of the outer side wall 70 and the inner side wall 72, each being composed of a hard material. As a result, the trim portion 66 does not come off the flange 12, even though no insert is embedded in the trim portion 66.

Consequently, in the weather strip 64, the insertion load against the flange 12 is about 24N/100 mm, and the extraction load from the flange 12 is about 48N/100 m, which are respectively similar to those of the conventional weather strip in which an insert is embedded (the insertion load is about 16N/100 mm and the extraction load is about 42N/100 mm). Therefore, the present embodiment is sufficient in insertion properties and holding forces against the flange 12.

The outer side wall 70, the bottom wall 74, and the inner side wall 72 are composed of a hard material of rubber or a thermoplastic elastomer so that the rigidity of the trim portion 66 is enhanced over an entire length thereof, whereby a great flange holding force can be effected with the outer side wall 70 and the inner side wall 72, even though no insert is embedded. In addition, since the hard material of rubber or the thermoplastic elastomer is subjected to extrusion without using any insert, the extrusion can be readily carried out, and high productivity can be effected.

The outer side wall 70, the bottom wall 74, and the inner side wall 72 are composed of a solid material of an EPDM rubber with a JIS hardness of 90 and a specific weight of 1.1. Therefore, where the flange 12 bends in conformity with the configuration of the vehicle body, they exhibit such flexibility as to follow the bending of the flange 12, and exhibit rigidity enough to hold the flange 12.

A first outer flange holding lip 80 and a second outer flange holding lip 82 respectively extend from an interior surface of the outer side wall 70 obliquely and upwardly into an interior space of the U-shaped trim portion 66, similarly to the conventional flange holding lips, whereas a first inner flange holding lip 84 and a second inner flange holding lip 86 similarly extend obliquely from an interior surface of the inner side wall 72 into the interior space of the U-shaped trim portion 66.

When the weather strip 64 is attached to the flange 12, the flange 12 can be stably held with two outer flange holding lips 80 and 82 and two inner flange holding lips 84 and 86.

The outer flange holding lips 80 and 82 and the inner flange holding lips 84 and 86 are composed of a solid material with a JIS hardness of 70 that is less than the hardness of the outer side wall 70, the bottom wall 74, and the inner side wall 72. Therefore, the outer side wall 70, the bottom wall 74, and the inner side wall 72 can hold the flange 12 strongly, and the outer flange holding lips 80 and 82 and the inner flange holding lips 84 and 86 can flexibly contact the flange 12, thereby securely holding the flange 12 even where there are irregularities, etc. on surfaces of the flange 12.

A body seal lip 88 projects obliquely and downwardly from an exterior face of an end of the outer side wall 70. The body seal lip 104 has a relatively great thickness that is approximately equal over the entire length thereof. A projecting end thereof is composed of a sponge material. When the body seal lip 88 contacts the opening surface 14 of the vehicle body, the projecting end thereof can linearly contact to increase the pushing force of the body seal lip 88, thereby improving the sealing properties. Therefore, the body seal lip 88 prevents intrusion of rainwater, dust, noise, etc. into a vehicle compartment from the opening surface 14 along the flange 12. As a result, seal between the opening surface 14 and the weather strip 64 can be provided.

In addition, where the body seal lip 88 is formed with an approximately equal thickness from a root to the projecting end thereof, the elasticity of the body seal lip 88 is improved, whereby the projecting end of the body seal lip 88 pushes the opening surface 14 with a strong force upon contacting the opening surface 14, and consequently good sealing properties are exhibited.

The body seal lip 88 is partly composed of a solid rubber near the outer side wall 70, and partly composed of a sponge material on the side of the projecting end thereof. With this arrangement, the flexibility of the body seal lip 88 increases, and consequently, the body seal lip 88 can readily flex in conformity with the irregularities and deformations of the opening surface 14 to ensure good sealing properties.

A sub-body seal lip 90 extends obliquely and downwardly from an interior surface of the opening end of the outer side wall 70. As shown in FIG. 4, the sub-body seal lip 90 is formed straight with a length less than those of the body seal lip 88 and the first outer flange holding lip 80. Consequently, when the weather strip 64 is attached to the flange 12, the sub-body seal lip 90 flexes and contacts a curved joint area between a root of the flange 12 and the opening surface 14. Since the sub-body seal lip 90 is formed small and thin, it can deform conforming to the curved configuration of the root of the flange 12 into close contact therewith, and consequently, even if rainwater, etc. pass through gaps between the body seal lip 88 and the opening surface 14, the sub-body seal lip 90 can securely prevent intrusion thereof into the vehicle compartment, and can also seal noise, etc., thereby further improving the sealing properties of the weather strip 64.

Where the sub-body seal lip 90 is composed of a sponge material, it exhibits improved flexibility, and consequently, flexes conforming to irregularities and deformations in the root of the flange 12, thereby ensuring good sealing properties.

A cover lip 92 projects from a lower part of the inner side wall 72 inwardly and downwardly of the vehicle body. After the weather strip 64 is attached to the flange 12, the cover lip 92 is arranged so as to cover ends of a garnish (not shown), panels (not shown), etc. provided in the vehicle compartment, whereby gaps between the weather strip 64, the garnish, the panels, etc., are sealed and covered to improve the appearance therearound.

Where the cover lip 92 is composed of a sponge material, it exhibits improved flexibility, and consequently, flexes according to variations in the gaps between the weather strip, the garnish, the panels, etc., thereby ensuring good sealing properties.

As shown in FIG. 4, a caulking member 94 may be attached to an interior surface of the bottom wall 74. By inserting an end of the flange 12 onto the caulking member 94, the sealing properties can be improved.

The tubular seal portion 68 is integrally formed on an exterior surface of the bottom wall 74 of the trim portion 68 so as to project upwardly. The tubular seal portion 68 has a generally lozenge, ellipsis or circle-shaped cross-section, and is composed of a sponge material, thereby exhibiting flexibility. When the trunk lid 16 is closed, the tubular seal portion 68 securely contacts the trunk lid 16 in position to provide a seal thereagainst without deforming, as compared with a lip-like seal portion. Where the tubular seal portion 68 has a generally lozenge or ellipsis-shaped cross-section, a protruding center thereof contacts the trunk lid 16 and flexes so as to contact the trunk lid 16 flexibly.

Where the tubular seal portion 68 is composed of a sponge material, the tubular seal portion 68 exhibits a great flexibility against the trunk lid 16, and a protruding end thereof can securely contact the trunk lid 16 in conformity with the configuration thereof, thereby exhibiting enhanced sealing properties.

When the trim portion 66 is mounted on the flange 12, the flange 12 is held with the outer flange holding lips 80 and 82 and the inner flange holding lips 84 and 86, and consequently, the weather strip 64 can be held with a stable posture.

As a result, the tubular seal portion 68 integrally formed with the trim portion 66 on the upper side of the exterior surface thereof, securely contacts a reverse surface of the trunk lid 16, thereby sealing a gap between the trunk lid 16 and the opening surface 14.

The sponge material adapted to compose the tubular seal portion 68, the body seal lip 88, the sub-body seal lip 90, the cover seal lip 92, etc. is formed of a foamed rubber body with a specific gravity of 0.4. The sponge material may have a specific gravity of 0.3 through 0.6 so that the weight of the weather strip 64 can be reduced, good elasticity and flexibility are exhibited, and good sealing properties can be effected over a long period of time.

The tubular seal portion 68 is formed to protrude from about a center of the exterior surface of the bottom wall 74 via a neck portion 96. By virtue of the neck portion 96, the tubular seal portion 68 can deform freely so as to provide a seal in conformity with the configuration of a facing member. Alternatively, the neck portion 96 can be composed of a solid material. In this case, the rigidity of the neck portion 96 is enhanced, thereby holding the position of the tubular seal portion 68 stably. As a result, when the tubular seal portion 68 contacts the opening surface 14 or a facing member, the contacting position can be made stable, thereby effecting good sealing properties.

The second embodiment of the present invention will be explained with reference to FIG. 5.

A weather strip 98 of the second embodiment is not provided with any body seal lip, sub-body seal lip or cover lip provided in the weather strip 64 of the first embodiment, and differs therefrom in configuration of an interior corner of a trim portion 100 of the weather strip 98. The remainder of the structure of the weather strip 98 is identical to that of the first embodiment, explanations thereof will be omitted, and only the different structure will be explained.

In the second embodiment, an interior surface 102 of a corner portion between an outer side wall 104 and a bottom wall 106 of the trim portion 100, and an interior surface 108 of a corner portion between an inner side wall 110 and the bottom wall 106 respectively define a tapered surface filling the corner portion with an increased wall thickness. Consequently, the rigidity of the corner portions of the trim portion 100 increases, whereby the outer side wall 104 and the inner side wall 110 are difficult to splayed apart so that the flange holding force of the trim portion 100 can be further increased.

In accordance with the present invention, the weather strip is formed using a synthetic rubber such as an EPDM rubber, etc., a thermoplastic elastomer such as a polyolefin elastomer, etc. Where EPDM rubber and thermoplastic olefin elastomer are used, co-extrusion can be carried out using materials of the same kind, whereby products with good weather resistance can be obtained. And since these materials are both olefin based resin and rubber, the obtained products can be recycled without being separated from each other, whereby readily recyclable products can be obtained.

Straight parts of the weather strip are formed by extruding a material with an extruder, and then cutting the extruded material into predetermined lengths. Parts of the weather strip, which are to be attached along corners, are formed by molding, and the straight parts are simultaneously jointed to each other by molding.

In the case of synthetic rubber, after extruded, the extruded material is transferred to a vulcanizing chamber, and heated therein with hot wind and high frequency waves, etc. for vulcanization. In the case of thermoplastic elastomer, the extruded material is cooled for solidification.

While the invention has been described in connection with what are considered to be the preferred embodiments, it is to be understood that the invention is not limited to the disclosed embodiments, but, on the contrary, is intended to cover various modifications and equivalent arrangements included within the spirit and scope of the appended claims.

What is claimed is:

1. A weather strip for a motor vehicle, which is to be attached to a flange around an opening in a vehicle body for sealing an opening surface of the vehicle body against a facing member, comprising:
a trim portion with a generally U-shaped cross-section, which is adapted to be attached to the flange and holding the weather strip; and
a tubular seal portion integrally formed with said trim portion for contacting the facing member and effecting a seal between the opening surface and the facing member,
said trim portion having an outer side wall, a bottom wall and an inner side wall, wherein
flange holding lips respectively extend from interior surfaces of said outer side wall and inner side wall,
an exterior surface of a corner between said bottom wall and said outer side wall, and an exterior surface of a corner between said bottom wall and said inner side wall are formed to have an angle of 90° through 100° such that angular parts in said corners are formed with a radius of curvature of 0.2 mm through 2.0 mm, and
said outer side wall, said bottom wall and said inner side wall respectively exhibit a JIS hardness of 75 through 100, and are respectively formed of a hard material of one of rubber and a thermoplastic elastomer with an apparent specific gravity of not less than 0.8.

2. A weather strip for a motor vehicle, as claimed in claim 1, wherein said flange holding lips respectively exhibit a JIS hardness of 65 through 75, and are respectively formed of one of rubber and a thermoplastic elastomer with an apparent specific gravity of not less than 0.8.

3. A weather strip for a motor vehicle, as claimed in claim 1, wherein said tubular seal portion is composed of a sponge material.

4. A weather strip for a motor vehicle, as claimed in claim 1, wherein said tubular seal portion is formed near a center of an exterior surface of said bottom wall via a neck portion.

5. A weather strip for a motor vehicle, as claimed in claim 4, wherein said neck portion is composed of a solid material.

6. A weather strip for a motor vehicle, as claimed in claim 1, further comprising a body seal lip that extends from an opening end of said outer side wall outwardly and obliquely downward to contact said opening surface of the vehicle body.

7. A weather strip for a motor vehicle, as claimed in claim 6, further comprising a sub-body seal lip that extends from an opening end of said outer side wall inwardly and obliquely downward to contact a position near a root of the flange, and a cover lip that projects from an opening end of said inner side wall inwardly to contact an inner body panel.

8. A weather strip for a motor vehicle, as claimed in claim 1, wherein said flange holding lips include two flange holding lips formed in an interior surface of said outer side wall and two flange holding lips formed in an interior surface of said inner side wall in deviated positions from each other.

9. A weather strip for a motor vehicle, as claimed in claim 1, wherein said weather strip is composed of one of an EPDM rubber and a thermoplastic olefin elastomer.

10. A weather strip for a motor vehicle, as claimed in claim 1, wherein said weather strip is one of a trunk weather strip and a back door weather strip.

11. A weather strip for a motor vehicle, as claimed in claim 1, wherein a thick wall part is provided inside one of said corner between said bottom wall and said outer side wall, and said corner between said bottom wall and said inner side wall.
